(19) United States
(12) Patent Application Publication
(10) Pub. No.: US 2003/0210151 A1
(43) Pub. Date: Nov. 13, 2003

(54) Water monitoring system and device

(76) Inventors: Royce Kimberlain, Garland, TX (US); Dale King, Garland, TX (US)

Correspondence Address: Steven W. Thrasher, 391 Sandhill Dr., Richardson, TX, 75080, US

(21) Appl. No.: 10/142,302

(22) Filed: May 9, 2002

(51) Int. Cl. G08B 21/00

(52) U.S. Cl. 340/604; 340/605

(57) ABSTRACT

The invention is a water monitoring system and device. The water monitoring system includes an alarm-processor unit that is communicatively connected to a water detector, preferably embodied as a sensor probe. A housing for the alarm-processor unit is adapted for attachment to an appliance. The invention provides alarm notification in the form of a high-pitched audible sound emitted from a speaker. In an alternative embodiment, the invention provides a user-adjustable control for adjusting the sensitivity level of the water monitor, and for adjusting a detected water level.

### TECHNICAL FIELD

Generally, the invention relates to water damage, and more particularly, the invention relates to systems and devices that reduce and prevent water damage.

### STATEMENT OF A PROBLEM ADDRESSED BY THIS INVENTION

Many appliances and plumbing fixtures such as hot water heaters, air conditioners, clothes washers, and dishwashers, for example, malfunction, resulting in water leakage and damage. For example, water supply hoses that come with most clothes washers tend to disintegrate over time, eventually rupturing and leaking large volumes of water. Also, water heaters can rust, crack, and become clogged due to mineral deposits in the storage reservoir. Sinks, basins, and tubs often overflow or have “pipe leaks.

With any of these malfunctions, water flows into unwanted areas and significant damage may occur. For example, walls, floors, carpets, furniture, personal computers and home filing systems are often damaged by water, resulting in significant costs to a resident and/or building owner. In addition to the water damage, there is often subsequent damage due to mold and mildew which can lead to unpleasant odors that make a residence unfit for habitation, or to “mold damage” claims on the insurance industry. In fact, several insurance carriers no longer insure homes in some states due to “black mold” claims.

These damages frequently are multiplied in multi-story dwellings as the water flows down into lower levels. Significant costs are frequently multiplied as carpets are replaced on more than one floor level. Two or more stories may need painting, light fixtures may need to be replaced, and ceiling tiles or other ceiling materials may need to be replaced. In addition, odor elimination may be required, which uses commercial fans and deodorant chemicals that add to the expense of uncontrolled water.

Currently, there are few methods for dealing with this problem. Although there are some expensive float ball options for air conditioners, this approach requires a trained technician to install the system. There are also crude water detection devices that detect water after is has been in the position to cause water damage. Accordingly, to overcome these and other disadvantages associated with water monitors, it would be advantageous to have a water monitoring system that provides a warning prior to water being in a position to cause damage. The invention disclosed herein provides such a system.

### SELECTED OVERVIEW OF SELECTED EMBODIMENTS

The invention provides technical and operational advantages as a water monitoring system. One embodiment provides a water detector coupled to an alarm-processing unit. Preferably, the water detector is adapted to sit or be positioned in an area that receives water at the first sign of leakage. In a preferred embodiment, the invention has an alarm-processing unit contained in a housing adapted for attachment to an appliance. Accordingly, the invention monitors and reports the presence of unwanted water when the water first appears on the scene, before any water damage occurs.

The invention, in one embodiment, can be attached to an appliance, such as a water heater, by using magnets or an adhesive. In an alternative embodiment, the invention provides a user the ability to select a sensitivity level for water detection. Thus, the invention provides a means that allows a user to prevent serious water damage by warning a user to take appropriate intervening action.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention and it should be understood that the invention is not limited by the detailed description. Accordingly, the invention should be read as being limited only by the claims.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 is a diagram of one embodiment of a water monitoring system;

FIG. 2 shows an alternative embodiment of a water monitoring system; and

FIG. 3 illustrates yet another alternative embodiment of a water monitoring system.

### AN EXEMPLARY EMBODIMENT OF A BEST MODE

The invention is a water monitoring system and device. The water monitoring system includes an alarm-processor unit that is communicatively connected to a water detector, preferably embodied as a sensor probe. A housing for the alarm-processor unit is adapted for attachment to an appliance. The invention provides alarm notification in the form of a high-pitched audible sound emitted from a speaker. In an alternative embodiment, the invention provides a user-adjustable control for adjusting the sensitivity level of the water monitor, and for adjusting a detected water level.

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment. Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in 112, paragraph 6 of 35 U.S.C., unless used as “means for functioning-” or “step” for -functioning-” in the claims section.

Description of the Drawings

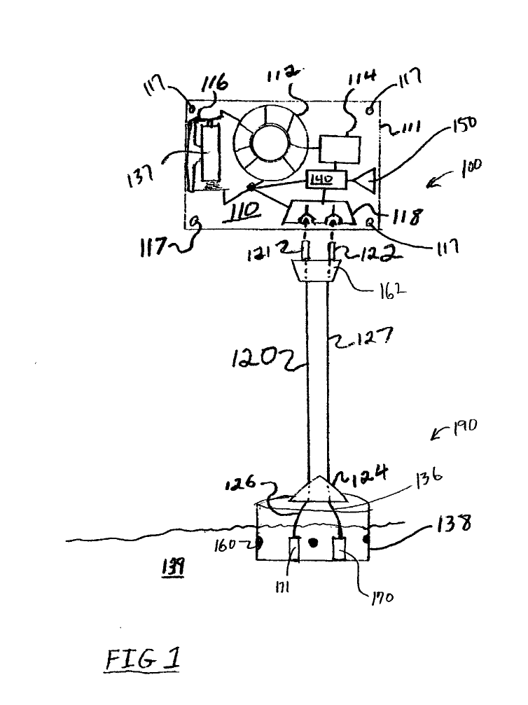

Better understanding of the invention can be gained by examination of the Figures. FIG. 1 is a bock-schematic of a water monitoring system 100 which generally includes a water detector 190 communicatively coupled via wires 120, 127 to an alarm-processing unit 110. The alarm processing unit 110 is maintained in a housing 111 that is adapted to attach to an appliance, such as common residential appliances like a water heater, an air conditioner, or a washer.

The alarm processing 110 unit includes a power source interface 116 that provides a connection to an electrical power source for the system. In this embodiment the power source is a battery 137, while in other embodiments the power source might be common alternating current, or some other source of electrical current. Accordingly, the interface 116 may be constructed from various materials and formed in various shapes to conform to the needs of the particular power source as is known to one of ordinary skill in the art.

Also provided by the alarm-processing unit is a plurality of screw-holes 117 so that a screw may to be used to mount the alarm-processing unit 110 to a surface. One feature of the invention is an audible alarm. Generally, the audible alarm includes an audible alarm generator (sound generator) 114 and a speaker 112. The speaker 112 is disposed within the housing 111. The sound generator 114 is preferably an electronic sound generator and creates a high frequency audible pitch signal that is converted to sound by the speaker 112.

A control circuit 140 provides the internal logic and current flow controls needed to implement the invention. In addition, in a preferred embodiment, the control circuit 140 is coupled to a user interface 150 that gives a user the ability to select a sensitivity levels for the water monitoring system 100. For example, a user may choose to select a sensitivity level that ignores water, and sounds an alarm only when a full closed circuit (in other words, water) is detected. This can be achieved in one embodiment by detecting a current flow of at least predetermined amperage level, since the amount of current flow depends, in part, on the water level at the water detector 190. Similarly, a user may choose to select a sensitivity level that detects a water level and sounds an alarm only after a predetermined water level is reached. A water level can be detected by attaching a variable resistor to the ends of probes in the water detector 190, as discussed below.

A receptacle 118 receives probes 121 and 122 of a plug 162. The plug 162 is coupled to the water detector 190 via wires 120, 127. Thus, the wires 120, 127 provide a communicative coupling that joins the alarm processing unit 110 to the water detector 190. In one embodiment, the wires 120, 127 are housed in a non-conductive cord (not shown). Of course, although a receptacle is illustrated and discussed herein, a receptacle is not a necessary element of the invention (as the water detector 190 may be directly coupled to the control circuit 140 of the alarm processing unit 110), as the invention's elements are defined only by the claims.

The water detector 190 is preferably housed in a nonconductive material. In the preferred embodiment of FIG. 1, the nonconductive housing includes a pill-box shaped portion 138 that has holes 160 for allowing the penetration of water into the water detector 190, as well as a cap having a conical portion 124. Preferably, the water detector 190 is adapted to conform to the shape of a water heater basin.

The wires 120, 127 enter the water detector 190 at the conical portion 124. The wires 120, 127 then terminate into a first probe 126 and a second probe 136. The first probe 126 is shown having a variable resistor 171, and the second probe is shown having a second variable resistor 172. The resistor varies linearly with height, such that the resistor has a low resistance at a point of connection with a probe, and a high resistance at the opposite end.

Thus, when water at a first low level conducts a current through the probes, a first voltage or current is generated across the probes 126, 136. Then, when water at a second level conducts current though the probes 126, 136, a second voltage or current is generated across the probes 126, 136. Thus, the control interface allows a user to select a water level to detect, which is in reality detecting a predetermined voltage or current across the probes 126, 136. In a preferred embodiment, only one variable resistor is used. A water level 139 is shown penetrating the water detector 190, and the water level is shown covering the probes 126, 136. Accordingly, in the condition illustrated in FIG. 1 an alarm would sound.

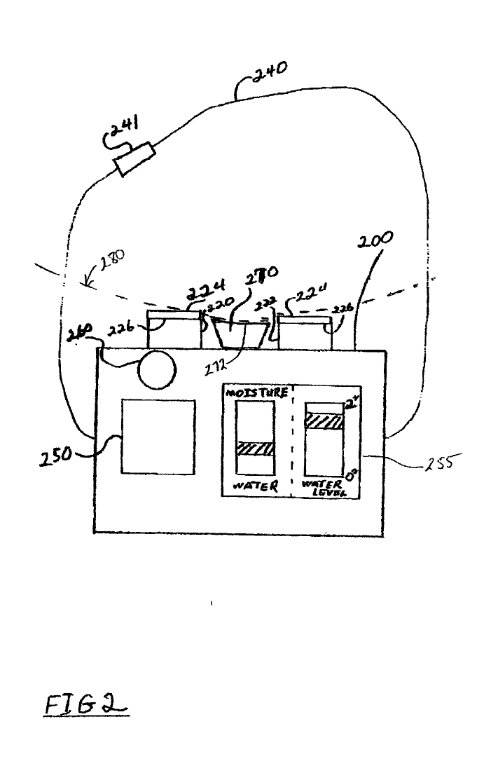

FIG. 2 provides additional detail of a preferred alarm processing unit housing 200 with illustrated features. The alarm-processing unit housing 200 provides a strap 240 having an adjustable belt-buckle 241 as a means of attachment to an appliance, such as a hot water heater signified by dashed lines 280. Additional means of attachment for coupling the housing 200 to an appliance include using an adhesive strip, or a magnet, for example. Since most water heaters have a generally cylindrical shape, a preferred embodiment of the invention uses a first mount 220 and a second mount 222 that together can attach to either a flat surface or a curved surface of an appliance.

Accordingly, in a preferred embodiment, the housing 200 includes the first mount 220 and the second mount 222, where each mount 220, 222 has a means of attachment 224 disposed on an attachable surface 226. In addition, each mount 220, 222 may have foam or other malleable material disposed between the means of attachment 224 and the attachable surface 226 so that the means of attachment will, to some degree, take the shape of the appliance the housing 200 is attached to. Thus, a malleable material provides a better surface for attaching the alarm-processing unit 200.

Additional integration with an appliance can be achieved with an appliance coupling means 270. Preferably, the appliance coupling means 270 is mountable to an appliance via a means of attachment (not shown) that is mounted to a contoured surface 272 of the appliance coupling means 270. The contoured surface 272 is shaped to take the surface contour of selected appliances, such as a hot water heater, an air conditioner, a pipe, or other appliance or plumbing device. Accordingly, the appliance coupling means can be either permanently or temporarily mounted to an appliance, and, likewise, can be temporarily or permanently attached to a housing 200. The result is that the housing 200 is more effectively coupled to an appliance or other device.

Also shown in FIG. 2 is an alarm-reset switch 250 for allowing a user to stop/reset an activated alarm, as well as a user interface 255 for a control circuit.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

I claim:

1. A water monitoring system for detecting the presence of water and for alerting a user to the presence of water, comprising:
a water detector; and
an alarm-processing unit communicatively coupled to the water detector.

2. The system of claim 1, wherein the alarm-processing unit is housed in a housing adapted to attach to a residential appliance.

3. The system of claim 1, wherein the water detector comprises:
a control circuit for controlling a voltage through the water detector; and
a communicative coupling means for coupling the water detector to the alarm-processing unit.

4. The system of claim 1 wherein the alarm-processing unit comprises:
an audible alarm generator;
an control circuit coupled to the audible alarm generator;
a power source interface coupled to the alarm generator; and
a communicative coupling means for connecting the alarm-processing unit to the water detector, the communicative coupling means being electrically coupled to the control circuit.

5. The system of claim 4 wherein the alarm-processing unit further comprises a receptacle coupled to the control circuit.

6. The system of claim 5 wherein the control circuit controls the sensitivity of the water detector to water, such that the water detector is enabled to ignore a predetermined amount of water.

7. The system of claim 5 wherein the control circuit controls the sensitivity of the water detector to a water level, such that the water detector is enabled to ignore a predetermined level of water.

8. The system of claim 4 wherein the communicative coupling means is a two-wire electrical cord.

9. The system of claim 3 wherein the water detector further comprises a first probe and a second probe, wherein the first probe and the second probe are coated with an electrolyte that promotes the conducting of an electrical current through water when the water detector is in water.

10. The system of claim 3 wherein the water detector has a first probe and a second probe, the said first probe being coupled to a male plug and the second probe being coupled to a male plug through the resistor.

11. The system of claim 10, wherein the first probe and the second probe are electrically isolated in a non-conductive and water penetrable housing.

12. The system of claim 1 wherein the water detector is adapted to fit in a water heater basin.

13. The system of claim 2 wherein the housing is adapted to attach to a water heater.

14. The system of claim 13 wherein the housing is adapted to magnetically attach to a water heater.

15. The system of claim 13 wherein the housing is adapted to attach to a water heater using a looped plastic and felt connection.

16. The system of claim 13, wherein the housing is adapted to attach to a surface using a mechanical coupling selected from one of the following: a plurality of screws, a plurality of bolts, a strap, or a plurality of brads.

17. The system of claim 13 wherein the housing is adapted to attach to a water heater using an adhesive.

18. An alarm processing unit, comprising:
a power source receptacle;
audible alarm coupled to the power source receptacle,
an control circuit coupled to the power source receptacle; and
a water detector receptacle electrically coupled to the control circuit.

19. The system of claim 18 wherein the power source receptacle is adapted to receive a battery.

20. The system of claim 18 wherein the control circuit controls the sensitivity of the control circuit to a voltage received at the water detector receptacle.
